(19) United States
(12) Patent Application Publication
(10) Pub. No.: US 2014/0145698 A1
(43) Pub. Date: May 29, 2014

(54) DC-DC CONVERTER

(71) Applicant: Kabushiki Kaisha Toshiba, Tokyo (JP)

(72) Inventors: Hiroshi SAITO, Tokyo (JP); Yuichi Goto, Kanagawa (JP); Ichiro Nishikawa, Kanagawa (JP)

(21) Appl. No.: 13/931,143

(22) Filed: Jun. 28, 2013

(30) Foreign Application Priority Data
Nov. 28, 2012 (JP) 2012-260118

(51) Int. Cl. G05F 1/46

(52) U.S. Cl. CPC G05F 1/468
USPC 323/285

(57) ABSTRACT

A DC-DC converter includes a signal generator that sets a first signal at a prescribed value when an input power supply voltage is at or lower than a prescribed voltage, a first voltage controller that generates a first voltage so that an output voltage rises gradually during a prescribed period of time, an error amplifier outputting a second signal corresponding to the voltage difference between the either the first voltage and a voltage correlated to the output voltage of the converter or a reference voltage and the voltage correlated to the output voltage, a signal processor that generates a third signal and a switch control signal for a high-side switch and a low-side switch on the basis of the first signal and the second signal, and an output voltage controller that causes the low-side switch to be turned off during a prescribed period from the start of the prescribed period.

### CROSS-REFERENCE TO RELATED APPLICATION

This application is based upon and claims the benefit of priority from Japanese Patent Application No. 2012-260118, filed Nov. 28, 2012, the entire contents of which are incorporated herein by reference.

### FIELD

Embodiments described herein relate generally to a DC-DC converter.

### BACKGROUND

A DC-DC converter may have a function of Under Voltage Lock Out (UVLO). With the UVLO function, when an input power supply voltage to a DC-DC converter is at a threshold voltage or lower, the operation of the DC-DC converter is paused to prevent a malfunction.

A conventional DC-DC converter also usually has a soft start function by which an output voltage rises gradually from a ground voltage after the converter operation is started. With the soft start function, the output voltage of the DC-DC converter is monitored and controlled so that no surge (rush) current flows.

When the soft start function is provided, a control is carried out such that when the output voltage does not fall to the ground voltage right after the start-up or the execution of the UVLO function, the output voltage is forcibly decreased to the ground voltage. In such a case, however, various problems take place. For example, when the output voltage is decreased to the ground voltage, a current higher than the current rating for an inductor in an output section of the DC-DC converter may flow in the opposite direction. Stopping this inductor current is difficult, and so the output voltage drastically falls to a negative potential and problems may arise on the system side that receives the voltage supplied from the DC-DC converter. In addition, charge stored in an output smoothing capacitor connected to an output terminal of the DC-DC converter is discharged wastefully, leading to an increase in power consumption.

### DESCRIPTION OF THE DRAWINGS

FIG. 1 is a block diagram illustrating the schematic configuration of a DC-DC converter according to a first embodiment.

FIG. 2 is a circuit diagram illustrating an example of a specific embodiment of the DC-DC converter shown in FIG. 1.

FIG. 3 is a diagram illustrating an example of a waveform of the operation of DC-DC converters depicted in FIG. 1 and FIG. 2.

FIG. 4 is a circuit diagram illustrating the schematic configuration of a DC-DC converter according to a second embodiment.

FIG. 5 is a circuit diagram illustrating an example of a specific embodiment of the DC-DC converter shown in FIG. 4.

FIG. 6 is diagram illustrating an example of a waveform of the operation of DC-DC converters depicted in FIG. 4 and FIG. 5.

### DETAILED DESCRIPTION

Embodiments provide a DC-DC converter, the output voltage of which does not significantly decrease prior to a soft start operation and increases gradually after the soft start operation.

According to one embodiment, there is provided a DC-DC converter including a signal generator configured to generate a first signal when an input power supply voltage is less than or equal to a prescribed voltage, a first voltage controller configured to generate a first voltage to control an output voltage of the converter so that the output voltage rises gradually during a prescribed period of time (a soft start period), an error amplifier, a signal processor, and an output voltage controller. The error amplifier is configured to output a second signal corresponding to a voltage difference between the first voltage and a voltage correlated to the output voltage when the first voltage is less than or equal to a reference voltage and to a voltage difference between the reference voltage and the voltage correlated to the output voltage when the first voltage is greater than the reference voltage. The signal processor is configured to generate a third signal and a switch control signal on the basis of the first signal and the second signal. The switch control signal controls a high-side switch and a low-side switch connected in series between the input power supply voltage and a ground voltage. The output voltage controller is configured to turn off the low-side switch during a start of the prescribed period of time.

Example embodiments will be explained by reference to figures.

### First Embodiment

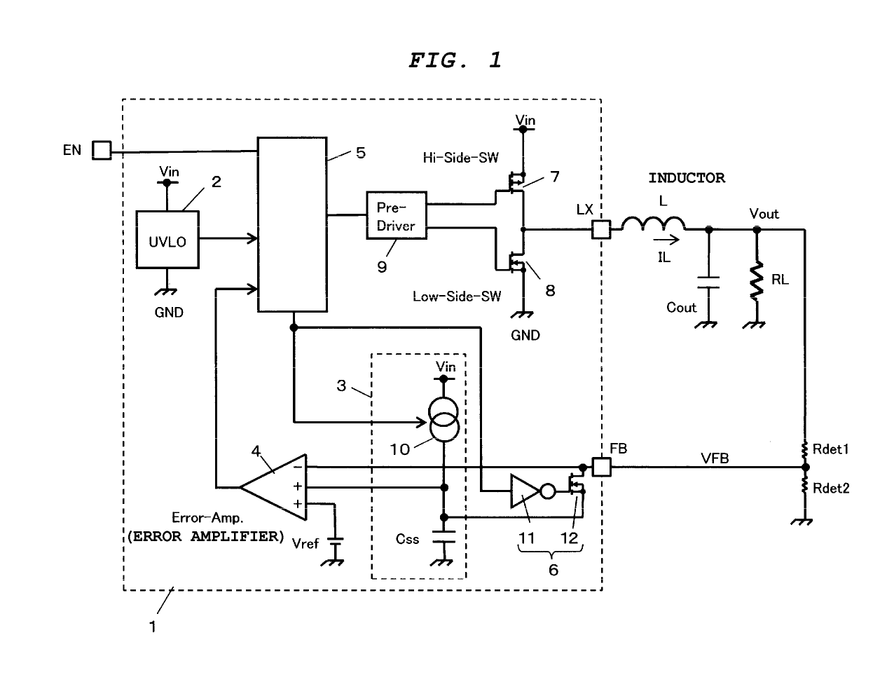

FIG. 1 is a block diagram illustrating the schematic configuration of a DC-DC converter 1 according to a first embodiment. The DC-DC converter 1 shown in FIG. 1 includes a UVLO circuit (a signal generator) 2, a soft start controller (a first voltage controller) 3, an error amplifier (an error-amp) 4, a signal processor 5, an output voltage controller 6, a high-side switch 7, a low-side switch 8, and a pre-driver 9.

The UVLO circuit 2 generates a first signal, for example, a high-level standby signal when it detects that an input power supply voltage Vin is a prescribed threshold voltage or lower. This first signal is input to the signal processor 5. When the first signal indicates Vin is at or below the prescribed threshold voltage (e.g., the first signal is at a high level), the signal processor 5 recognizes the converter state as a standby state.

The soft start controller 3 generates a soft start voltage (a first voltage) VCss so that an output voltage Vout of the DC-DC converter 1 rises gradually within a soft start period (a prescribed period) after the start (initial start-up) or the recovery from the standby state.

In one example, as shown in FIG. 1, the soft start controller 3 includes a current source 10 and a soft start capacitor Css connected in series between the input power supply voltage Vin and a ground voltage. The voltage between the current source 10 and the soft start capacitor Css is the soft start voltage VCss.

The error amplifier 4 outputs a signal (a second signal) corresponding to the voltage difference between the soft start voltage VCss or a reference voltage Vref and a voltage correlated to the output voltage Vout. The voltage correlated to the output voltage Vout is, for example, a divided voltage VFB obtained by a dividing the output voltage Vout with the resistors Rdet1 and Rdet2.

The comparison operation carried out by the error amplifier 4 depends on the difference between the soft start voltage VCss and the reference voltage Vref. Specifically, the error amplifier 4 compares the reference voltage Vref with the voltage correlated to the output voltage Vout (e.g., VFB) when the soft start voltage VCss is higher than the reference voltage Vref, and when the soft start voltage VCss is the reference voltage Vref or lower, the error amplifier compares the soft start voltage VCss with the voltage correlated to the output voltage Vout.

On the basis of an output signal of the UVLO circuit 2 and an output signal of the error amplifier 4, the signal processor 5 generates a signal (hereinafter to be referred to as a third signal) indicating the standby state, and a switch control signal for controlling the high-side switch 7 and the low-side switch 8.

After the start of the soft start period, the output voltage controller 6 performs a control so that, as will be described below, the low-side switch 8 is turned off, and thus, no current flows to the low-side switch 8 via an inductor L connected to a connecting node LX between the high-side switch 7 and the low-side switch 8 during the prescribed period from the start of the soft start period.

For example, as shown in FIG. 1, the output voltage controller 6 includes an inverter 11 that inverts the third signal output from the signal processor 5, and an NMOS transistor (a voltage coincidence controller) 12 is turned on/off by an output signal of the inverter 11. The divided voltage VFB (i.e., the voltage correlated to the output voltage Vout in this embodiment) is applied to a drain of the NMOS transistor 12, and the soft start voltage VCss is applied to a source of the NMOS transistor 12. Consequently, corresponding to an output of the inverter 11, the NMOS transistor 12 switches the yes/no of coincidence between the divided voltage VFB and the soft start voltage VCss. Specifically, during the period of the standby state, the NMOS transistor 12 causes the voltage correlated to the output voltage Vout to be in coincidence with the soft start voltage VCss.

The high-side switch 7 and the low-side switch 8 are connected in series between the input power supply voltage Vin and the ground voltage. Specifically, the input power supply voltage Vin is applied to a source of the high-side switch 7 made of a PMOS transistor, and a drain is connected to one end LX of the inductor L. A drain of the low-side switch 8 made of the NMOS transistor is connected to one end LX, and a source is set at the ground voltage.

Corresponding to the switch control signal from the signal processor 5, the pre-driver 9 controls and switches the high-side switch 7 and the low-side switch 8.

From the other end of the inductor L not connected to high-side switch 7 and low-side switch 8, the output voltage Vout is output. Between the other end of the inductor L and the ground voltage, an output smoothing capacitor Cout and an output resistor RL are connected in parallel with each other. Also in parallel with the output smoothing capacitor Cout and the output resistor RL, two resistors Rdet1 and Rdet2 are connected in series between the other end of the inductor L and the ground voltage. The divided voltage VFB fed from the point between the resistors Rdet1 and Rdet2. The voltage VFB is thus correlated to output voltage Vout. The divided voltage VFB is fed to the drain of the NMOS transistor 12 in the output voltage controller 6 and a negative input terminal of the error amplifier 4.

A portion surrounded by a broken line in FIG. 1 can optionally be formed as an integrated circuit (IC). The various circuit elements outside of the broken line would typically be attached externally to the IC. Also, an IC incorporating only some circuit elements depicted within the broken line, such as the high-side switch 7 and the low-side switch 8, etc., may also be externally attached in some embodiments.

The soft start capacitor Css in the soft start controller 3 may either be externally attached or included in the IC. As far as the resistors for generating the divided voltage VFB are concerned, when a variable output voltage Vout is to be generated, they may preferably be externally attached. On the other hand, when a fixed output voltage Vout is to be generated, they may preferably be included in the IC.

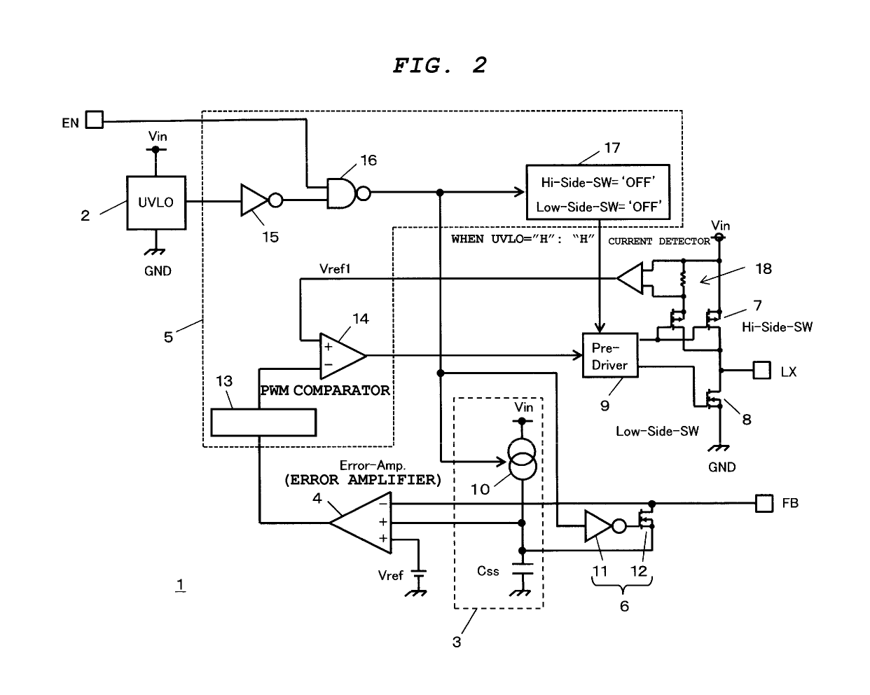

FIG. 2 is a circuit diagram illustrating an example of a specific embodiment of a DC-DC converter 1 depicted in FIG. 1. The signal processor 5 shown in FIG. 2 includes a phase compensation circuit 13, a PWM (pulse width modulation) comparator 14, an inverter 15, a NAND gate 16 and a logic operation circuit 17.

The DC-DC converter 1 shown in FIG. 2 is of a current mode type. A reference voltage Vref1 is generated by a current detector 18. Vref1 corresponds to a current flowing in the high-side switch 7. The reference voltage Vref1 and a feedback signal from the error amplifier 4 are compared by the PWM comparator 14, and the obtained comparison signal is used to drive the pre-driver 9.

The logic operation circuit 17 signals to turns off both the high-side switch 7 and the low-side switch 8 when a signal indicating the standby state is output from the UVLO circuit 2 and when an enable signal EN indicates a disabled state.

The specific configuration of the DC-DC converter 1 is not limited to that depicted in FIG. 2. For example, a voltage mode type may also be adopted. In the case of the voltage mode type, a triangular wave voltage signal is usually input as the reference voltage Vref1.

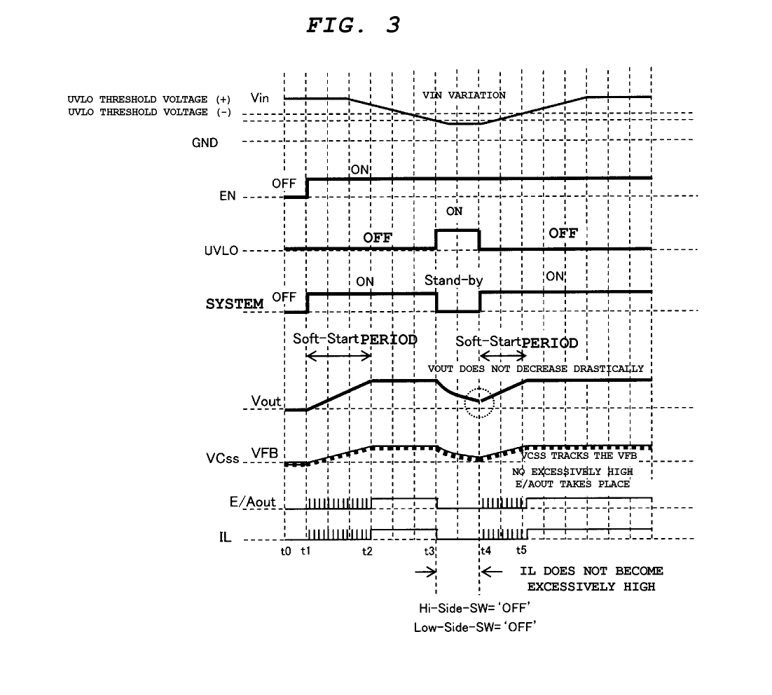

FIG. 3 is a diagram illustrating an example of a waveform of the operation of the DC-DC converter 1 depicted in FIG. 1 and FIG. 2. In the example shown in FIG. 3, during the period from time t0 to time t1, the enable signal EN is on the low level, and the DC-DC converter 1 is in the state of stop. At the time t1, the enable signal EN becomes the high level, and the DC-DC converter 1 starts. The period between time t1 and t2 is the soft start period. At the time t1, both the soft start voltage VCss and the output voltage Vout become nearly the ground voltage, and the error amplifier 4 generates a signal corresponding to the voltage difference between the soft start voltage VCss and the divided voltage VFB (i.e., the voltage correlated to the output voltage Vout). The signal processor 5 controls the switching the high-side switch 7 and the low-side switch 8 corresponding to the output signal of the error amplifier 4 so that the soft start voltage VCss and the divided voltage VFB are in coincidence with each other. As a result, both the soft start voltage VCss and the output voltage Vout rise gradually.

At the time t2, the soft start voltage VCss becomes over the reference voltage Vref, and the soft start period comes to an end. Then, the error amplifier 4 generates a signal corresponding to the voltage difference between the reference voltage Vref and the divided voltage VFB. Also, the signal processor 5 controls and switches the high-side switch 7 and the low-side switch 8 according to the output signal of the error amplifier 4 so that the reference voltage Vref and the divided voltage VFB are in coincidence with each other.

Then, due to a certain cause, the input power supply voltage Vin decreases. As the UVLO circuit 2 detects at time t3 that the input power supply voltage Vin is at or lower than the threshold voltage, the first signal is set to, for example, the high level and input to the signal processor 5.

As shown in FIG. 3, the UVLO circuit 2 uses two threshold voltages (indicated as (+) and (−) in FIG. 3) at different voltage levels. This helps prevent chattering by having a hysteresis in the comparison treatment.

Here, the UVLO circuit 2 sets the first signal on the high level indicating the standby state to the signal processor 5 during the period between time t3 and t4. Upon receiving this signal, the signal processor 5 supplies the third signal with, for example, the low level to the soft start controller 3. This third signal is at the low level during the standby state.

When the third signal is set to the low level at the time t3, the current source 10 in the soft start controller 3 stops operation. At the same time, the NMOS transistor 12 in the output voltage controller 6 is turned on, and a control is carried out so that the soft start voltage VCss and the divided voltage VFB are in coincidence with each other. In this way, in the standby state, the soft start voltage VCss and the divided voltage VFB become the same voltage level.

The signal processor 5 turns off both the high-side switch 7 and the low-side switch 8 during the standby period. Consequently, the output voltage Vout decreases gradually, and, in company with this decrease, the divided voltage VFB and the soft start voltage VCss also decrease.

Then, as depicted in FIG. 3, the input power supply voltage Vin increases gradually, and, at the time t4, the UVLO circuit 2 releases the standby state. As a result, the NMOS transistor 12 in the output voltage controller 6 is turned off.

The period between time t4 and t5 after the release of the standby state is the soft start period. Just as in the period between the time t1 and t2, a current flows from the current source 10 to the soft start capacitor Css in the soft start control circuit, and the soft start voltage VCss gradually increases.

Also, during the soft start period between the time t4 and t5, the error amplifier 4 outputs a signal corresponding to the voltage difference between the soft start voltage VCss and the divided voltage VFB. Then, corresponding to the output signal of the error amplifier 4, the signal processor 5 controls and switches the high-side switch 7 and the low-side switch 8, so that the output voltage Vout and consequently the divided voltage VFB gradually increases.

In the present embodiment, during the standby period, the NMOS transistor 12 is turned on, and a control is carried out so that the soft start voltage VCss and the divided voltage VFB are in coincidence with each other. Consequently, during the soft start period, the low-side switch 8 is prevented from being turned on, and the output voltage Vout do not become a voltage lower than the ground voltage.

At the time t5, the soft start voltage VCss exceeds the reference voltage Vref, and the soft start period comes to an end. Then, the error amplifier 4 outputs a signal corresponding to the voltage difference between the reference voltage Vref and the divided voltage VFB. The signal processor 5 controls and switches the high-side switch 7 and the low-side switch 8 so that the divided voltage VFB and the reference voltage Vref are in coincidence with each other.

In this way, according to the first embodiment, the output voltage controller 6 is arranged inside of the DC-DC converter 1. When the state becomes the standby state, the divided voltage VFB, the voltage correlated to the output voltage Vout, is made to coincide with the soft start voltage VCss, so that, when the transition is made from the standby state to the soft start period, there is no voltage difference between the divided voltage VFB and the soft start voltage VCss. Consequently, during the soft start period, the operation for keeping the low-side switch 8 on in order to decrease the output voltage Vout is not carried out, and the drastic decrease in the output voltage Vout can be suppressed, and so, preventing problems for the system that uses the DC-DC converter 1 as the power supply is possible. Also, it is possible to avoid the problem of a high current greater than the current rating flowing through the inductor L right after the soft start period. In addition, there is no wasteful discharge of the charge left in the output smoothing capacitor Cout that is output right after the soft start period, and so, suppressing the wasteful consumption of the power is possible.

### Second Embodiment

In the second embodiment, in the soft start period, when it is detected that current flows from the inductor L to the low-side switch 8, the low-side switch 8 is turned off.

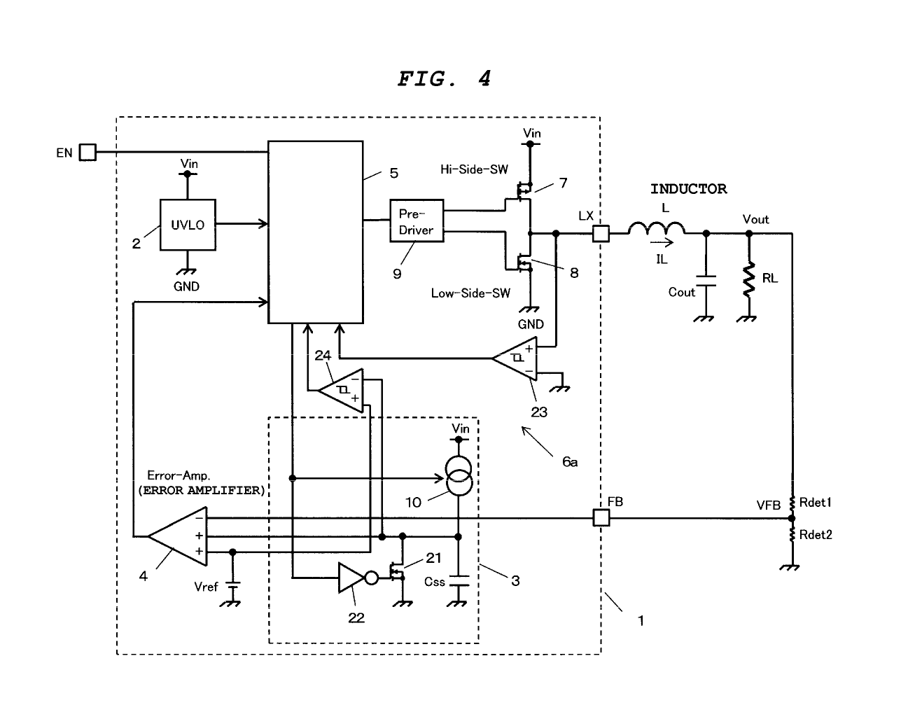

FIG. 4 is a block diagram illustrating the schematic configuration of the DC-DC converter 1 according to the second embodiment. The same reference numerals as those used in FIG. 1 are adopted in FIG. 4, and, in the following, only the significant differences will be explained.

For the soft start controller 3 shown in FIG. 4, the soft start controller includes a discharge switch 21 and an inverter 22. The discharge switch 21 is turned on in the standby period so that the charge stored in the soft start capacitor Css is discharged.

In addition, as depicted in FIG. 4, an output voltage controller 6a which is different from the output voltage controller 6 is incorporated. The output voltage controller 6a includes a zero cross comparator (a first comparator) 23, which detects that a voltage (hereinafter to be referred to as an inductor voltage VLX) at the connecting node between the drain of the low-side switch 8 and the inductor L (is at the ground voltage or higher, and a soft start detection comparator (a second comparator) 24 that detects that the operation is in the soft start period. The first comparator outputs a signal (a fourth signal) to the signal processor 5 that indicates whether the inductor voltage VLX is at or below the reference voltage Vref. The second comparator outputs a signal (a fifth signal) to the signal processor 5 that indicates whether the soft start voltage VCss is at or below the reference voltage Vref.

The soft start detection comparator 24 compares the soft start voltage VCss with the reference voltage Vref. If the soft start voltage VCss is at the reference voltage Vref or lower, the soft start detection comparator 24 determines that the operation is in the soft start period and outputs, for example, a high-level signal.

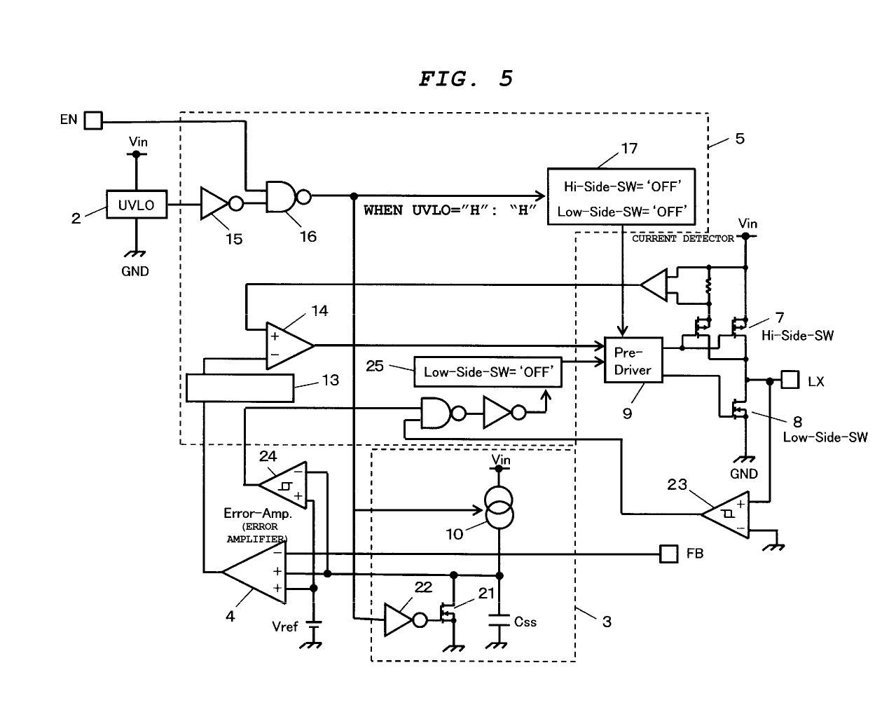

FIG. 5 is a circuit diagram illustrating a specific example embodiment of the DC-DC converter 1 depicted in FIG. 4. The signal processor 5 depicted in FIG. 5 includes a logic operation circuit 25 that carries out a logic operation between an output signal of the zero-cross comparator 23 and an output signal of the soft start detection comparator 24. During the soft start period, when the inductor voltage VLX exceeds the ground voltage, the logic operation circuit 25 generates a signal that turns off the low-side switch 8. The output signal of the logic operation circuit 25 is input to the pre-driver 9.

The DC-DC converter 1 in FIG. 4 and FIG. 5 includes discharge switch 21 in the soft start controller 3. Consequently, during the standby period, the soft start voltage VCss decreases to the ground voltage. On the other hand, during the standby period, both the high-side switch 7 and the low-side switch 8 are turned off, and the output voltage Vout and the divided voltage VFB gradually decrease.

Right after the end of the standby period, when the soft start period begins, the divided voltage VFB is higher than the soft start voltage VCss. Consequently, the signal processor 5 turns on the low-side switch 8 so that the output voltage Vout is decreased. As a result, due to the stored charge in the output smoothing capacitor Cout, a current flows from the inductor L through the low-side switch 8 to the ground terminal.

As the current in the direction described above flows, the inductor voltage VLX exceeds the ground voltage, and the output signal of the zero-cross comparator 23 becomes the high level. In this case, the output signal of the soft start detection comparator 24 is also on the high level, and the logic operation circuit 25 outputs a signal that indicating that the low-side switch 8 is to be turned off. Upon receiving this signal, the pre-driver 9 turns off the low-side switch 8. As a result, the low-side switch 8 is turned off, a current flowing in the direction from the output smoothing capacitor Cout via the inductor L to the low-side switch 8 is stopped, and the decrease in the output voltage Vout is suppressed.

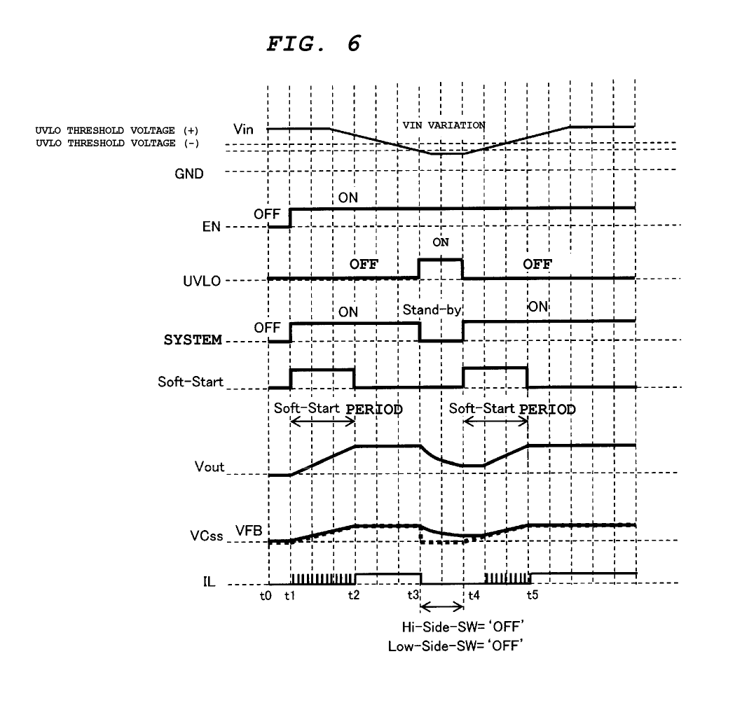

FIG. 6 is a diagram illustrating an example of a waveform of the operation of the DC-DC converter 1 shown in FIG. 4 and FIG. 5. At time t1, the enable signal EN becomes the high level, so that the DC-DC converter 1 is started, and a waveform of the operation in the period between time t0 and t3 is the same as that in the period between time t0 and t3 shown in FIG. 3.

During the standby state at time t3, the discharge switch 21 is turned on and the stored charge in the soft start capacitor Css is quickly discharged via the discharge switch 21, so that the soft start voltage VCss decreases to the ground voltage. On the other hand, in the standby state, both the high-side switch 7 and the low-side switch 8 are turned off so that the output voltage Vout and the divided voltage VFB gradually decrease.

After the end of the standby period at time t4, when the soft start period begins, the divided voltage VFB is higher than the soft start voltage VCss, so that an output signal of the error amplifier 4 becomes the high level. The signal processor 5 that receives the output signal from the error amplifier 4 turns on the low-side switch 8 so that the output voltage Vout and the divided voltage VFB decrease. As a result, a current due to the stored charge of the output smoothing capacitor Cout flows via the inductor L to the low-side switch 8, and the output signal of the zero-cross comparator 23 becomes the high level. In this case, because the output signal of the soft start detection comparator 24 is also on the high level, the logic operation circuit 25 outputs a signal for turning off the low-side switch 8. As a result, the low-side switch 8 is turned off, and the output voltage Vout and the divided voltage VFB increase gradually instead of increasing drastically.

In this way, according to the second embodiment, during the soft start period, as a back flow of current takes place in the inductor L, the low-side switch 8 is turned off. Consequently, the output voltage Vout does not decrease drastically during the soft start period, and the level of the output voltage Vout of the DC-DC converter 1 can be stabilized. Also, as in the first embodiment, it is also possible to prevent the flow of a current above the rating of the inductor L right after the soft start period begins. In addition, there is no wasteful discharge of the charge left in the output smoothing capacitor Cout right after the soft start period begins, thus cutting power consumption.

In the first and the second embodiments, a voltage decreasing-type DC-DC converter 1 is explained as an example. However, the present invention may also be adopted in a voltage boosting type, an inverted type, or a boosting/decreasing type DC-DC converter 1.

While certain embodiments have been described, these embodiments have been presented by way of example only, and they are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A DC-DC converter, comprising:
a signal generator configured to generate a first signal having a prescribed level when an input power supply voltage is less than or equal to a prescribed voltage;
a first voltage controller configured to generate a first voltage to control an output voltage;
an error amplifier configured to output a second signal corresponding to a voltage difference between the first voltage and a voltage correlated to the output voltage when the first voltage is less than or equal to a reference voltage and to a voltage difference between the reference voltage and the voltage correlated to the output voltage when the first voltage is greater than the reference voltage;
a signal processor configured to generate, on the basis of the first signal and the second signal, a third signal and a switch control signal for controlling a first switch and a second switch connected in series between the input power supply voltage and a ground voltage; and
an output voltage controller configured to turn off the second switch during a start of the prescribed period of time.

2. The DC-DC converter according to claim 1, wherein the output voltage controller comprises a voltage coincidence controller configured to cause the voltage correlated to the output voltage to coincide with the first voltage when the third signal is at a level that indicates a standby state.

3. The DC-DC converter according to claim 1, wherein the first voltage controller comprises a current source and a capacitor connected in series between the input power supply voltage and the ground voltage.

4. The DC-DC converter according to claim 3, wherein the voltage coincidence controller includes a switching element configured to cause a voltage at a connecting node between the current source and the capacitor to coincide with the voltage correlated to the output voltage when the third signal is at the level that indicates a standby state; and
the current source does not charge the capacitor in the first voltage controller when the third signal is at the level that indicates a standby state and charges the capacitor during the prescribed period of time.

5. The DC-DC converter according to claim 1, wherein the output voltage controller is configured to generate a control signal that causes the second switch to be turned off when a current flowing into the second switch via an inductor during the prescribed period of time is detected.

6. The DC-DC converter according to claim 5, wherein the first voltage controller comprises:
a current source and a capacitor connected in series between the input power supply voltage and the ground voltage; and
a discharge circuit configured to discharge the capacitor when the third signal is at a level that indicates a standby state; and
the output voltage controller comprises:
a first comparator configured to detect a current flowing into the second switch via the inductor; and
a second comparator configured to detect whether the operation is in the prescribed period of time on the basis of a comparison between the reference voltage and the first voltage.

7. The DC-DC converter according to claim 6, further comprising:
a logic operation circuit configured to generate the control signal, wherein detection of the current flowing into the second switch via the inductor during the prescribed period of time is made on the basis of an output of the first comparator and an output of the second comparator.

8. The DC-DC converter according to claim 1, wherein the voltage correlated to the output voltage is a voltage obtained by dividing the output voltage with a resistor.

9. The DC-DC converter according to claim 1, wherein the converter is a current mode type.

10. The DC-DC converter according to claim 1, further comprising a current detector configured to detect a current flowing through the first switch and to generate a first reference voltage corresponding to the current flowing through the high side switch.

11. The DC-DC converter according to claim 1, wherein the signal processor includes a phase compensation circuit configured to receive the second signal, and a pulse width modulation comparator configured to compare a signal from the phase compensation circuit to the first reference voltage to generate the third signal.

12. The DC-DC converter according to claim 1, further comprising a pre-driver circuit configured to receive the switch control signal and to apply a control voltage to the first switch and the second switch.

13. A DC-DC converter, comprising:
a signal generator configured to generate a first signal having a prescribed level when an input power supply voltage is less than or equal to a prescribed voltage;
a first voltage controller configured to generate a first voltage to control an output voltage;
an error amplifier configured to output a second signal corresponding to a voltage difference between the first voltage and a voltage correlated to the output voltage when the first voltage is less than or equal to a reference voltage and a voltage difference between the reference voltage and the voltage correlated to the output voltage when the first voltage is greater than the reference voltage;
a signal processor configured to generate a third signal and a switch control signal for controlling a first switch and a second switch connected in series between the input power supply voltage and a ground voltage;
a first comparator configured to compare a voltage at a drain of the second switch to a ground voltage and to output a fourth signal to the signal processor that indicates whether the voltage of the drain of the second switch is at or below the ground voltage; and
a second comparator configured to compare the first voltage to the reference voltage and to output a fifth signal to the signal processor that indicates whether the first voltage is at or below the reference voltage, wherein
the signal processor generates the third signal on the basis of the first signal, and the switch control signal on the basis of the first signal, the second signal, the fourth signal, and the fifth signal.

14. The DC-DC converter of claim 13, wherein the first voltage controller comprises a current source and a capacitor connected in series between the input power supply voltage and the ground voltage.

15. The DC-DC converter of claim 14, wherein the first voltage controller further comprises a discharge circuit configured to discharge the capacitor when third signal indicates a standby state.

16. The DC-DC converter of claim 13, wherein the signal processor is configured to generate the switch control signal to switch both the first switch and the second switch to off when the first signal indicates the input power supply voltage is greater than the prescribed voltage, and to generate the switch control signal to turn the second switch off when the fourth signal indicates the voltage of the drain of the second switch is at or below the ground voltage.

17. A method for controlling a DC-DC converter, comprising:
receiving a first signal indicating whether an input power supply voltage is less than or equal to a prescribed voltage;
receiving a second signal corresponding to (a) a voltage difference between a first voltage and a voltage correlated to an output voltage from a DC-DC converter when the first voltage is less than or equal to a reference voltage and (b) a voltage difference between the reference voltage and the voltage correlated to the output voltage when the first voltage is greater than the reference voltage;
generating a third signal to indicate that the converter is in a standby state; and
generating a switch control signal for controlling a first switch and a second switch connected in series between the input power supply voltage and a ground voltage, the switch control signal generated on the basis of the first signal and the second signal, wherein
the switch control signal controls the first switch and the second switch.

18. The method of claim 17, further comprising:
receiving an enable signal indicating whether the DC-DC converter is in an on-state or an off-state,
wherein the switch control signal controls the first switch and the second switch.

19. The method of claim 17, further comprising:
receiving a fourth signal that indicates whether a voltage of a drain of the second switch is at or below the ground voltage; and
receiving a fifth signal that indicates whether the first voltage is at or below the reference voltage,
wherein the switch control signal causes the second switch to be in an off-state when the fourth signal indicates the voltage of the drain of the second switch is at or below the ground voltage.

20. The method of claim 19, wherein the switch control signal causes the second switch to be in an off-state when the fifth signal indicates the first voltage is at or below the reference voltage.
